(19) United States
(12) Patent Application Publication
(10) Pub. No.: US 2009/0265158 A1
(43) Pub. Date: Oct. 22, 2009

(54) Complex Consolidation of Multiple Works

(76) Inventor: James L. Barlow, Fort Collins, CO (US)

Correspondence Address: SANTANGELO LAW OFFICES, P.C., 125 SOUTH HOWES, THIRD FLOOR, FORT COLLINS, CO, 80521, US

(21) Appl. No.: 12/424,369

(22) Filed: Apr. 15, 2009

Related U.S. Application Data
(60) Provisional application No. 61/045,918, filed on Apr. 17, 2008.

(51) Int. Cl. G06F 17/28; G06F 17/27

(52) U.S. Cl. 704/2; 704/9

(57) ABSTRACT

Systems and methods for creating a consolidated work or article may include the consolidation of the four canonical Gospels of Luke, Matthew, John, and Mark whereby selections of original text may be compared, separated, and linked to create a new paragraph of amalgamated text, each word thereof having source indicia to identify the Gospel source resulting in a coalescent compilation of the four canonical Gospels into a single work. A coalescent compilation may include unique paragraphs and text from each of the four Gospels and may even include all of the unique text from each of the four canonical Gospels.

This application claims the benefit of U.S. Provisional Application No. 61/045,918, filed Apr. 17, 2008, hereby incorporated by reference herein.

### BACKGROUND OF THE INVENTION

Central to the Christian faith are the books that comprise the New Testament portion of the Bible. Among them, the four Gospels (Matthew, Mark, Luke and John) undeniably rank supreme in terms of their importance. Without the Gospel accounts, there would be no Jesus, no savior and no Christianity.

While the Synoptic Gospels (Matthew, Mark and Luke) present somewhat of a “common view”, they are indeed very different with many unique details and accounts intertwined between them. All of the Gospels may have been arranged on a topical basis by their respective writers to varying extents and thus were not written chronologically.

When studying any ancient literary work, and especially the Bible, it may be important to understand the context of the words that were penned. Context may include geographical setting, chronology, original language, cultural aspects, and the like. In order to have the most complete picture of the life, ministry and teachings of Jesus as presented in the Gospels, all four may be viewed on a collective basis and also in chronological order with regard to each specific passage.

One example of how a reader may draw a completely wrong conclusion when studying the Gospels may be where Jesus called his first disciples, Peter, Andrew, James and John (Matthew 4:12-22; Mark 1:14-20; and Luke 5:1-11). When reading these three accounts on their own, it may appear that Jesus walked along the Sea of Galilee and called out to these four simple fishermen to drop the lives they had known and blindly follow him. However, when chronologically compared to the Gospel of John, a completely different conclusion is determined. John alone discloses the detail that Peter and Andrew had known Jesus for some time and thus had a relationship with him prior to Jesus calling them to follow him (John 1:29-51). They had spent personal time with him, heard him teach and even seen him perform miracles before they left their lives of fishing to become his disciples.

Several works have been produced which may provide chronological and parallel arrangements of the four Gospels. One of the more widely accepted accounts is the “NIV Harmony of the Gospels” by Robert L. Thomas and Stanley N. Gundry, HarperOne, 1998, hereby incorporated by reference. This publication is actually an updated version of the original work by A. T. Robertson and John Broadus, principally to publish it in the NIV. The book attempts to arrange the various Gospel passages in a parallel and chronological order. While this work may aid a student of the Bible who desires to look at parallel passages side by side, the reader may still be left to discern the various details provided between the four accounts. The “NIV Harmony of the Gospels” may not be the only publication that has provided a parallel arrangement. In fact, modern software tools may exist that can also identify parallel passages, including the “Gospel Parallels” by Phillip P. Kapusta, www.pc-shareware.com/gospelwin.htm, hereby incorporated by reference.

Others, such as “Jesus the Messiah: A Survey of the Life of Christ” by Robert H. Stein, InterVarsity Press, 1996, hereby incorporated by reference, provide commentary, apologetics, detailed evaluations and perspectives of the four original Gospel accounts. While providing illumination of the Gospels in many ways, including a challenge from which one begins a study of Jesus, as noted by Stein, they do not provide the Gospel text or arrangement, but rather write about the original accounts.

Another work in this field is: “Four Voices—One Gospel”, by James R. Robinson, Quest Publishing, 1992, hereby incorporated by reference. This literary composition may consist of two principal components, the first of which the author refers to as “The Synergistic Gospel” and the second, the “Parallel Gospel”. The Synergistic Gospel is a compilation of the four original Gospel accounts (Matthew, Mark, Luke and John) in the King James Version (“KJV”), but not in a chronological order and not using visual enhancement to identify the original Gospel source.

Other prior works, whereby each are hereby incorporated by reference herein, in this field include:
“One—The Unified Gospel of Jesus—Divine Version” by Gregg R. Zegarelli, OUG Press, Ltd, 2006.
“Four Gospels, One Jesus: A Symbolic Reading by Richard A. Burridge, Wm. B. Eerdmans Publishing Company, 1994—illustrates the author's view of the unique portraits of Jesus presented by the four original Gospels.
“Four Color Synopsis” by Stephen Carlson, www.mindspring.com/˜scarlson/synopt/harmony, 1996—color comparison of the four Synoptic Gospels together with the original Greek text (available on the internet only).
“The Gospels and Jesus” by Graham N. Stanton, Oxford University Press, 2002—a Biblical study of the Gospels and the life of Jesus.
“The Five Gospels Parallels” by John W. Marshall, http://www.utoronto.ca/religion/synopsis/syn-ini.htm, 1996-2001 (available on the internet only)—provides a parallel arrangement of the four original Gospels together with The Gospel of Thomas.
“A Synoptic Gospels Primer” by Mahlon H. Smith, http://virtualreligion.net/primer, 1997-2007 (available on the internet only)—a Primer created principally as a study tool for critical analysis of the Synoptic Gospels that provides a summary overview and literary analysis of each of the three original accounts, together with Greek synopsis and the Synoptic problem.
“A Harmony of the Four Gospels” by Orville E. Daniel, Baker Books, 1996—a parallel arrangement of the four original Gospels in the NIV together with background and commentary.
“The Chronological Life of Christ: From Glory to Galilee” by Mark E. Moore, College Press Publishing, 1996 (two volume edition)—a chronological study of the life of Christ based upon the four original Gospel accounts.
“A Short Life of Christ” by Everett Harrison, Wm. B. Eerdmans Publishing Company, 1968—a discussion on the life of Christ based upon the four original Gospel accounts.
“Charts of the Gospels and the Life of Christ”, Robert L. Thomas, Zondervan, 2000—a study resource for the Gospel accounts that includes useful charts and graphs for chronological assessment and analysis of the life of Christ.

### SUMMARY OF THE INVENTION

It is therefore an object of the present invention, in embodiments, to provide methods and processes for consolidating and providing a chronological arrangement of the four Gospels.

It is another object of the present invention, in embodiments, to provide a consolidated arrangement of the four Gospels, such consolidation labeled to identify the original Gospel source.

Naturally, further objects, goals and embodiments of the inventions are disclosed throughout other areas of the specification and drawings.

### BRIEF DESCRIPTION OF THE DRAWINGS

FIGS. 1 and 2 show a schematic of a consolidation system according to one embodiment of the invention for consolidation of the four Canonical Gospels.

### DETAILED DESCRIPTION OF THE PREFERRED EMBODIMENTS

The present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

While the previous referenced prior works may serve as tools to allow for chronological arrangement of the Gospels or perhaps even for side by side comparison, no work has ever been produced in any language or translation that compiles the four Gospels into one single literary work that is arranged on a chronological basis and which preserves the unique text from the four original Gospels. Further, no compilation like this has ever been produced where visual enhancement, such as color, fonts, underlining, bolding, italics, borders, shading, highlighting, or the like may be incorporated which may enable the reader to identify the unique original Gospel source text and also the text that is paralleled.

Embodiments of the present invention may include the process of compiling all four Gospels, such as the four canonical Gospels (Matthew, Mark, Luke and John) and perhaps even, in other embodiments, consolidation of accounts other than the canonical Gospels into a single work which may be titled as The Accord. The present invention may provide, in embodiments, processes for consolidating the four Gospels into a single account which may result in a work which may include but is not limited to:
a chronological arrangement;
exclusion of duplicative text, for example, text that may also be stated by one of the other writers;
a visual identification of the original Gospel source using enhancements such as underlining, highlighting, italics, bolding, color, and the like;
a visually identifiable text that may be paralleled by at least two of the Gospel sources, such as with bold text and the like;
a record which references the eliminated text perhaps because it may also have been included by one of the other writers; and perhaps even
a written commentary on the passages that may analyze and may discuss the pertinent aspects of the compiled account.
   It is noted that any identification may be used in the consolidation process to identify the original Gospel source, paralleled text, or the like. Such identification includes, but is not limited to various fonts, underlining, highlighting, italics, bolding, colors, and the like.

Embodiments of the present invention may include consolidation methods including but not limited to:
Selecting a translation, paraphrase or language source such as The New International Version;
Color coding or using any alternative visual identifier for each of the original Gospel sources so that text from each Gospel can be traced to its original source author. For example, Matthew could be coded black, Mark may be coded blue, Luke may be coded red, and John may be coded green;
identifying passages in the four Gospels that may be paralleled by two or more of the writers and arranging all parallel passages together;
Using time and chronological text references within the Gospel passages, arranging each of the passages on a chronological basis perhaps while keeping parallel passages together. The textual references may include statements by one or more of the writers such as: “the next day . . . ”, “then . . . ” “six days later . . . ” and so on. Paralleled passages may be kept together in the chronological arrangement;
For each passage that may be paralleled, embodiments may provide selecting a base text such as Matthew, generally on the basis of which author provided a majority of detail for each respective paralleled passage. While comparing each of the parallel passages, one may move unique statements from the other account(s) such as Mark's to an appropriate location in the base text. Unique statements to be moved to the base text may include but are not limited to single words, phrases, whole sentences, paragraphs, and passages from the other parallel sources. Where there may be apparent discrepancies, it may be desirable to include both versions by noting one in parentheses while the other account reads as originally stated in the source text;
Carefully reviewing the text not moved to the compiled account to ensure that the details from the paralleled accounts are included; and perhaps even
Maintaining text that is not included in the compiled account in a reference source.

### Sample Text:

An example of what a compiled account may look like using the New International Version for the passage titled: “Feeding the Five Thousand” could be as follows:

Matthew 14:14-21

Mark 6:30-44

Luke 9:10-17

John 6:1-13
When the apostles returned, they reported to Jesus all they had done and taught. Then, because so many people were coming and going that they did not even have a chance to eat, he said to them, “Come with me by yourselves to a quiet place and get some rest.” So they went away by themselves in a boat to a solitary place to the far shore of the Sea of Galilee (that is, the Sea of Tiberias) to a town called Bethsaida. But many who saw them leaving recognized them and ran on foot from all the towns and got there ahead of them because they saw the miraculous signs he had performed on the sick.
When Jesus landed and saw a large crowd, he welcomed them. Then Jesus went up on a mountainside and sat down with his disciples. The Jewish Passover Feast was near. There was plenty of grass in that place, and the men sat down, about five thousand of them. He had compassion on them, because they were like sheep without a shepherd. So he began teaching them many things and spoke to them about the kingdom of God, and healed those who needed healing.
Late in the afternoon the Twelve came to him and said, “Send the crowd away so they can go to the surrounding villages and countryside and find food and lodging, because we are in a remote place here and it's already getting very late.” He replied, “They do not need to go away. You give them something to eat.”
He said to Philip, “Where shall we buy bread for these people to eat?” He asked this only to test him, for he already had in mind what he was going to do. Philip answered him, “Eight months' wages would not buy enough bread for each one to have a bite!Are we to go and spend that much on bread and give it to them to eat?” Another of his disciples, Andrew, Simon Peter's brother, spoke up, “Here is a boy with five small barley loaves and two small fish, but how far will they go among so many?” “Bring them here to me,” he said.
Then Jesus directed them to have all the people sit down in groups on the green grass. So they sat down in groups of hundreds and fifties. Jesus then took the five loaves and the two fish and looking up to heaven, he gave thanks and broke the loaves. Then he gave them to the disciples, and the disciples gave them to those who were seated as much as they wanted. He did the same with the fish. When they had all had enough to eat, he said to his disciples, “Gather the pieces that are left over. Let nothing be wasted.” So they gathered them and filled twelve baskets with the pieces of the five barley loaves left over by those who had eaten. After the people saw the miraculous sign that Jesus did, they began to say, “Surely this is the Prophet who is to come into the world.” The number of those who ate was about five thousand men, besides women and children.

In this non-limiting example above, each of the four Gospels are identified using plain text for the text from Matthew, italics for the text from Mark, underlining for the text from Luke, a box for the text from John, and bolding for the paralleled text between at least two of the Gospels. Of course, any identification may be used.

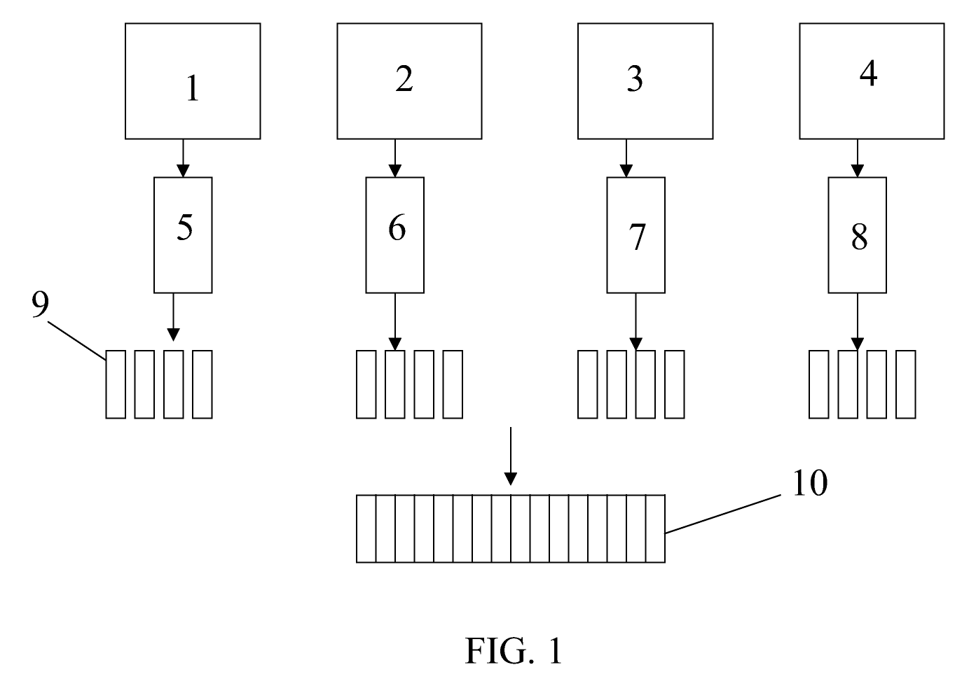

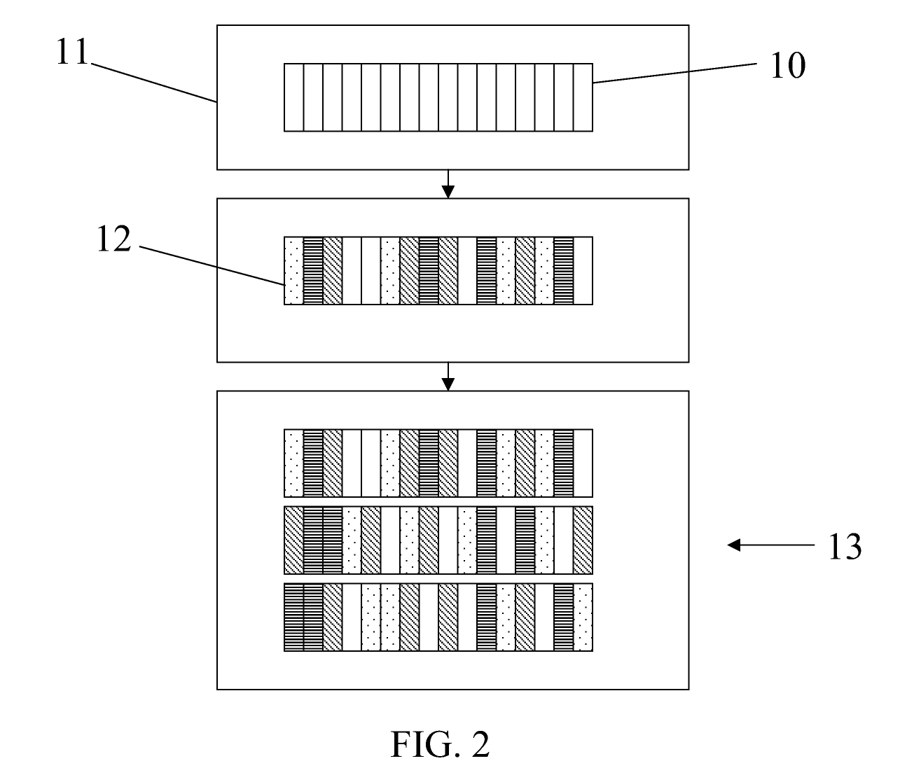

As can be understood from FIGS. 1 and 2, one embodiment of the present invention may include a specific method for the consolidation of the four canonical Gospels of Luke, Matthew, John, and Mark. Original text from each of the four canonical Gospels of Luke (1), Matthew (2), John (3), and Mark (4) may be obtained as shown in FIG. 1. The original text may include but is not limited to a translation in the English language, the English translation of the New International Version, a language other than English, a paraphrase in the English language, or perhaps even a paraphrase using a language other than the English language. A complementary piece of textual words may be selected from at least two of the four Gospels to provide perhaps Luke complementary text (5) or Matthew complementary text (6) or John complementary text (7) or Mark complementary text (8). The complementary texts may be compared to each other and may even be separated into fragments (9). Each fragment of the complementary texts may be physically linked to each other until all of the fragments may be compiled to a paragraph (10) of amalgamated text which is different or even substantially different from the original text. As one non-limiting example, a base text may be selected and the fragments from the other complementary pieces of text may be pieced together from the base text. A paragraph of amalgamated text may be placed in a tangible medium (11) such as but not limited to paper, documents, electronic file, web page, electronic documents and the like mediums.

In one embodiment, the fragments may be linked so that they are arranged to provide text in chronological order. Fragments may also be linked by moving a fragment before another fragment, moving a fragment after another fragment, deleting a fragment, and perhaps even overlapping fragments which may be identical and include duplicative text. When fragments are linked, it may be desirable to add common text to the fragments such as verbatim, connective components, additional words or the like to provide a grammatically consistent article. As a non-limiting example, the words, “and”, “or”, “the”, “next”, “then” or the like may be used. Source indicia (12) may be added to the amalgamated text which may identify the original Gospel source for each word of the text and may even identify any newly added text. Source indicia (12) may be any type of identification which indicates the original source of each of the words of the paragraph including but not limited to visual enhancement or perhaps even visual identification of the text, colors, italics, highlighting, underlining, fonts, borders, shading, bolding, symbols, footnotes, endnotes, parentheses, quotes, brackets, and the like. Identification may also be provided to show where the text may be parallel such as with bolding or other indicia as discussed herein. Duplicative text may be maintained in a separate record such as but not limited to an Appendix for reference purposes. A separate record may otherwise provide a record of original text for reference purposes perhaps even in a separate portion of the article. Another embodiment may include titles with each paragraph of said amalgamated text and perhaps even a table of contents.

This may be repeated with additional complementary pieces of textual words selected from an original text of the Gospels to create an additional paragraph of amalgamated text. The additional paragraphs of amalgamated text can be combined to provide a coalescent compilation (13) of the four canonical Gospels of Luke, Matthew, John, and Mark as may be understood in FIG. 2. In embodiments, additional complementary pieces of textual words may be selected and consolidated until all of the original text from each of the four Gospels have been incorporated into a coalescent compilation. For example, unique text from each of the Gospels may be provided in the compilation or perhaps all of the unique text from each of the Gospels may be incorporated so that all of the original unique source text may be compiled into one document. Alternatively, entire passages of text unique to only one of the four Gospels may be incorporated into a coalescent compilation. In embodiments, it may be desirable to provide a coalescent compilation which incorporates all of the text from all of the four Gospels. Perhaps one exception to using all of the text may be to exclude the text which is essentially paralleled by one or more of the other Gospels.

In addition to the coalescent compilation, a narrative may be included which may provide an analysis of the compiled passages, discussion of the passage, historical background, cultural context, grammatical or original language context, discussion of the unique portions of text provided by each of the original source Gospels, discussion of the intent of the passage rationale for chronological placement, discussion of the various views among the original accounts, discussion of the meaning of critical words from the original source language (for example, Greek), and other pertinent aspects pertaining to the compiled Gospel account. Of course, in other embodiments, other works such as other accounts or even any other written textual bodies of work may be used in a consolidation system as herein described.

As can be easily understood from the foregoing, the basic concepts of the present invention may be embodied in a variety of ways. It involves both consolidation techniques as well as devices to accomplish the appropriate consolidation. In this application, the consolidation techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of an “enhancement” should be understood to encompass disclosure of the act of “enhancing”—whether explicitly discussed or not—and, conversely, were there effectively disclosure of the act of “enhancing”, such a disclosure should be understood to encompass disclosure of an “enhancement” and even a “means for enhancing.” Such changes and alternative terms are to be understood to be explicitly included in the description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in any information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the consolidation devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. A method for creating a consolidated work comprising the steps of:
obtaining original text from each of four canonical Gospels of Luke, Matthew, John, and Mark;
fastidiously selecting a complementary piece of textual words from at least two of said four original text of the canonical Gospels of Luke, Matthew, John, and Mark to provide Luke complementary text, Matthew complementary text, John complementary text, or Mark complementary text;
comparing said at least two selected complementary texts to each other;
separating each of said complementary texts into fragments;
physically linking each fragment of said complementary texts until all of said fragments are compiled to provide a paragraph of amalgamated text which is different from said complementary piece of textual words from said original text;
adding source indicia to said amalgamated text, wherein said source indicia identifies the Gospel source for each word of said amalgamated text;
repeating said steps of:
fastidiously selecting said complementary piece of textual words from at least two of said four canonical Gospels;
comparing said at least two selected complementary texts;
separating each of said complementary texts into fragments;
physically linking each fragment of said complementary texts; and
adding source indicia to said amalgamated text;
with additional complementary pieces of textual words to create an additional paragraph of amalgamated text; and
providing a coalescent compilation of said four canonical Gospels of Luke, Matthew, John, and Mark.

2. The method according to claim 1 wherein said step of providing a coalescent compilation of said four canonical Gospels comprises the step of providing a chronologically arranged coalescent compilation.

3. The method according to claim 1 wherein said step of physically linking said fragments of said complementary texts comprises the step of overlapping said fragments when said fragments are identical to exclude duplicative text.

4. The method according to claim 1 wherein said fragments comprises text selected from a group consisting of a single word, a phrase, a sentence, a paragraph, and a passage.

5. The method according to claim 1 wherein said source indicia comprises a visual enhancement of the text.

6. The method according to claim 5 wherein said visual enhancement is selected from a group consisting of colors, italics, highlighting, underlining, fonts, borders, shading, and bolding.

7. The method according to claim 5 wherein said visual enhancement comprises identification that the text is paralleled by one or more of the Gospel writers.

8. The method according to claim 5 wherein said visual enhancement comprises bolded text to identify that it is paralleled by one or more of the Gospel writers.

9. The method according to claim 3 wherein said duplicative text is maintained in a separate record for reference purposes.

10. The method according to claim 9 wherein said separate record comprises an Appendix.

11. The method according to claim 1 wherein said coalescent compilation is completed using text selected from a group consisting of a translation in the English language, a language other than English, a paraphrase in the English language, and a paraphrase using a language other than the English.

12. The method according claim 1 and further comprising a narrative with said coalescent compilation, said narrative is selected from a group consisting of analysis of the compiled passages, discussion of the passage, historical background, cultural context, grammatical or original language context, discussion of the unique portions of text provided by each of the original source Gospels, discussion of the intent of the passage rationale for chronological placement, discussion of the various views among the original accounts, discussion of the meaning of critical words from the original source language, and other pertinent aspects pertaining to the compiled Gospel account.

13. The method according to claim 1 and further comprising the step of adding original text from accounts other than the canonical Gospels during said steps of selecting, comparing, separating, linking, and adding source indicia.

14. The method according to claim 1 and further comprising the step of placing said paragraph of amalgamated text in a tangible medium, said tangible medium selected from a group consisting of paper, document, electronic file, web page, and electronic document.

15. The method according to claim 1 wherein said four canonical Gospels are from the English translation of the New International Version.

16. The method according to claim 1 and further comprising the step of selecting a base text from one of the complementary piece of textual works.

17. The method according to claim 1 wherein said step of separating each of said complementary texts into fragments comprises the step of cutting each of said complementary texts into fragments.

18. The method according to claim 1 wherein said step of physically linking each fragment of said complementary text comprises moving said fragments, wherein said movement is selected from a group consisting of moving a fragment before another fragment, moving a fragment after another fragment, overlapping a fragment onto another fragment, and deleting a fragment.

19. The method according to claim 1, and further comprising the step of incorporating entire passages of text unique to only one of the four canonical Gospels in said coalescent compilation of said four canonical Gospels of Luke, Matthew, John, and Mark.

20. The method according to claim 1, wherein said coalescent compilation of said four canonical Gospels of Luke, Matthew, John, and Mark comprises unique text from all of the original text of each of the four canonical Gospels of Luke, Matthew, John, and Mark.

21. The method according to claim 20, wherein said unique text comprises all of said unique text from each of said four canonical Gospels of Luke, Matthew, John, and Mark.

22. A consolidated article comprising:
a coalescent compilation of text arranged from textual words from each of the four canonical Gospels of Luke, Matthew, John, and Mark, wherein said coalescent compilation comprises:
at least one paragraph of amalgamated text which is different from an original text of each of said four canonical Gospels; wherein said amalgamated text comprises linked fragments of separated text from at least two of said four canonical Gospels of Luke, Matthew, John, and Mark; and
at least one source indicia associated with each word of said amalgamated text indicating its origination Gospel source.

23. A consolidated article according to claim 22 wherein said at least one source indicia comprises a visual identification.

24. A consolidated article according to claim 22 wherein said at least one source indicia is selected from a group consisting of colors, italics, highlighting, underlining, fonts, borders, shading, and bolding.

25. A consolidated article according to claim 22 wherein said coalescent compilation of text further comprises a chronological structuring of the original canonical Gospels.

26. A consolidated article according to claim 22 wherein said coalescent compilation further comprises entire passages of text unique only to one of the four canonical Gospels.

27. A consolidated article according to claim 22 wherein said coalescent compilation further comprises unique text from each of the four canonical Gospels of Luke, Matthew, John, and Mark.

28. A consolidated article according to claim 27 wherein said unique text comprises all of said unique text from each of the four canonical Gospels of Luke, Matthew, John, and Mark.

29. A consolidated article according to claim 22 and further comprising indicia associated with at least some of said amalgamated text which has been included by two or more of the original Gospels.

30. A consolidated article according to claim 29 wherein said indicia comprises bolding of text.

31. A consolidated article according to claim 22 and further comprising a record of original text for reference purposes in a separate portion of the article.

32. A consolidated article according to claim 22 wherein said coalescent compilation further comprises unique text from said Gospels and common text.

33. A consolidated article according to claim 22 wherein said at least one paragraph of amalgamated text further comprises connective components to provide a grammatically consistent article.

34. A consolidated article according to claim 33 and further comprising a visual identification associated with said connective components to identify text which is newly added and not part of the original text of the Gospels.

35. A consolidated article according to claim 34 wherein said visual identification comprise parentheses.

36. A consolidated article according to claim 22 wherein said coalescent compilation further comprises a narrative, said narrative is selected from a group consisting of analysis of the compiled passages, discussion of the passage, historical background, cultural context, grammatical or original language context, discussion of the unique portions of text provided by each of the original source Gospels, discussion of the intent of the passage rationale for chronological placement, discussion of the various views among the original accounts, discussion of the meaning of critical words from the original source language, and other pertinent aspects pertaining to the compiled Gospel account.

37. A consolidated article according to claim 22 wherein said coalescent compilation further comprises a title for each paragraph of said amalgamated text and a table of contents.
